(19) United States
(12) Patent Application Publication
(10) Pub. No.: US 2004/0001706 A1
(43) Pub. Date: Jan. 1, 2004

(54) Method and apparatus for moving focus for navigation in interactive mode

(75) Inventors: Kil-Soo Jung, Gyeonggi-do (KR); Jung-Wan Ko, Gyeonggi-do (KR); Hyun-Kwon Chung, Seoul (KR); Jung-Kwon Heo, Seoul (KR); Sumg-Wook Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/465,601

(22) Filed: Jun. 20, 2003

(30) Foreign Application Priority Data
Jun. 29, 2002 (KR) 2002-37515

(51) Int. Cl. H04N 5/781; H04N 5/85; H04N 5/90; H04N 5/91

(52) U.S. Cl. 386/125

(57) ABSTRACT

A focusing method and a focusing apparatus in an interactive mode, and a data storage medium are provided. The focusing method includes identifying a domain of a resource to which a focused element refers when a command to move a focus between focusing layers is input from a user, and moving the focus by converting the focus-moving command into a command appropriate for the identified domain, when the identified domain is not a mark-up document domain.

### CROSS-REFERENCE TO RELATED APPLICATIONS

This application claims the priority of Korean Patent Application No. 2002-37515, which was filed on Jun. 29, 2002, in the Korean Intellectual Property Office, the disclosure of which is incorporated herein in its entirety by reference.

### BACKGROUND OF THE INVENTION

1. Field of the Invention

The present invention relates to a method and an apparatus for reproducing contents recorded on a data storage medium in an interactive mode.

2. Description of the Related Art

DVDs (referred to as interactive DVDs), from which AV data can be reproduced in an interactive mode using a personal computer (PC), are now being commercialized in the market. An interactive DVD generally stores AV data, which are recorded based upon conventional DVD-Video standards, and mark-up documents for supporting an interactive function. AV data recorded on an interactive DVD can be reproduced in two different modes. The first mode is a video mode in which the AV data are played in the same manner as data recorded on a typical DVD-video, and the second mode is an interactive mode in which the reproduced AV data are displayed on an AV screen in an embedded display window in mark-up documents. For example, if the AV data are a movie title, a movie is shown in the display window on a display screen, and various additional information, such as the scenario, synopsis, or actors' and actresses' photos, can be shown on the rest of the display screen. The additional information may be displayed in synchronization with the title (AV data). For example, when an actor or actress appears in a movie title, a mark-up document containing his or her personal history can be displayed as additional information.

A specific element of a mark-up document includes a start tag, content, and an end tag. An operation associated with the specific element can be performed by a user selecting the specific element and inputting a predetermined command. The state of the specific element being selected by the user is referred to as a ‘focus-on’ state.

There are different focusing methods. First, a predetermined element can be set up in a focus-on state by using a pointing device, such as a mouse or a joystick.

Second, a sequence of elements to be set up in a focus-on state is determined, and then the elements are sequentially set up in a focus-on state based upon the sequence by using an input device, such as a keyboard. A mark-up document creator may determine the sequence of elements to be set up in a focus-on state by using a ‘tabbing order’. A user can sequentially focus elements by using a tab key of a keyboard.

Third, an access key value is set up, and then an element is set up in a focus-on state using the access key value input from a user input device.

FIGS. 1A and 1B are diagrams illustrating data displayed in an interactive mode. Referring to FIGS. 1A and 1B, in an interactive mode, an AV screen obtained by reproducing AV data is embedded and displayed in a mark-up screen obtained by interpreting a mark-up document. FIG. 1A shows a focus-on state of an AV screen (a), and FIG. 1B shows a focus-on state of a link 1 (b).

However, in the related art, on a screen displayed in an interactive mode, only elements of a mark-up document can be navigated following a focusing method. In other words, in an interactive mode, it is impossible to control an object (for example, a DVD-video) which belongs to a different domain from a mark-up document domain but is embedded in a mark-up screen via a specific element using an ‘object’ tag, by using the same focusing method as used for a mark-up document.

In addition, in an interactive mode, there are two main domains, i.e., a mark-up document domain and a DVD-video domain, which can be navigated by a user. These domains support different navigation manners, and thus it is preferable that they have their own navigation keys. However, in the case of a home appliance using a user input device having a limited number of keys, such as a remote controller, it is ineffective to provide different navigation keys for navigating different domains to a user input device.

### SUMMARY OF THE INVENTION

Accordingly, it is an aspect of the present invention to provide a data storage medium on which data are recorded so that an object of a domain other than a mark-up document domain, which is embedded in a mark-up screen, can be navigated in an interactive mode.

It is another aspect of the present invention to provide an apparatus and a method for navigating a mark-up screen and an object of a domain other than a mark-up document domain, which is embedded in the mark-up screen, in an interactive mode by using a limited user input device.

It is a further aspect of the present invention to provide a data storage medium on which data are recorded so that a mark-up screen and elements in an object of a domain other than a mark-up document domain, which are embedded in the mark-up screen, can be navigated by moving a focus using a limited user input device.

It is yet another aspect of the present invention to provide a method and an apparatus for navigating elements in an object of a domain other than a mark-up document domain, which is embedded in a mark-up, screen in an interactive mode by moving a focus using a limited user input device.

Additional aspects and/or advantages of the present invention will be set forth in part in the description that follows, and, in part, will be obvious from the description, or may be learned by practicing the present invention.

According to an embodiment of the present invention, there is provided a data storage medium including AV data, and a mark-up document used for reproducing the AV data in an interactive mode. Here, the mark-up document is made using a focusing hierarchy structure so that a resource to which an element of the mark-up document refers and a domain of which is different from that of the mark-up document can be navigated.

In an embodiment, the AV data are DVD-video data, and the mark-up document is made using the focusing hierarchy structure so that the DVD-video data can be navigated.

According to another aspect of the present invention, there is provided a focusing method in an interactive mode where AV data are reproduced using a mark-up document. The focusing method includes identifying a domain of a resource to which a focused element refers when a command to move a focus between focusing layers is input from a user, and moving the focus by converting the focus-moving command into a command appropriate for the identified domain, when the identified domain is not a mark-up document domain.

According to still another aspect of the present invention, there is provided a focusing method in an interactive mode where AV data are reproduced using a mark-up document. The focusing method includes focusing on one of a plurality of mark-up document elements belonging to a top focusing layer, identifying a domain of resource to which the focused mark-up document element refers when a command to move a focus down to a first lower focusing layer is input from a user, and moving the focus by converting the focus-moving command into a command appropriate for the identified domain, when the identified domain is not a mark-up document domain.

In an embodiment, the focusing method includes canceling the conversion of the focus-moving command when a command to move the focus up to the top focusing layer is input from the user.

In an embodiment, the focusing method includes identifying a domain of a second lower focusing layer when a command to move a focus to the second lower focusing layer is input from the user, and moving the focus by converting the focus-moving command input from the user into a command appropriate for the identified domain.

According to yet still another aspect of the present invention, there is provided a focusing method in an interactive mode where DVD-video data are reproduced using a mark-up document. The focusing method includes focusing on an “OBJECT” element, identifying a resource to which the “OBJECT” element refers when a command to move a focus to a lower focusing layer is input from a user, and moving a highlight by converting the focus-moving command that is input from the user into a command to move a corresponding highlight defined in the DVD-video data.

In an embodiment, the moving the highlight comprises moving a highlight in a menu screen based upon the focus-moving command that is input from the user.

According to another aspect of the present invention, there is provided an apparatus to reproduce AV data in an interactive mode using a mark-up document including an AV decoder to decode the AV data, a presentation engine to interpret the mark-up document, and a blender to blend the interpreted mark-up document and the decoded AV data. Here, when a command to move a focus between focusing layers is input from a user, the presentation engine identifies a domain of a resource to which a focused element refers and converts the focus-moving command that is input from the user into a command appropriate for the identified domain only when the identified domain is not a mark-up document domain.

According to still another aspect of the present invention, there is provided an apparatus to reproduce AV data in an interactive mode using a mark-up document, including an AV decoder to decode the AV data, a presentation engine to interpret the mark-up document, and a blender to blend the interpreted mark-up document and the decoded AV data. Here, the presentation engine comprises an input unit to receive a command to move a focus between elements of a same focusing layer or between different focusing layers from a user input device, a focusing hierarchy information manager to provide focusing hierarchy information, a focusing manager to show elements that can be focused on in a current focusing layer, to convert the focus-moving command input from the user input device into an API command corresponding to a selected domain, to receive the focusing hierarchy information from the focusing hierarchy information manager so as to move a focus, and to perform a predetermined operation on a focused element when a perform command is input from the user input device, and an output unit to output interactive contents to the blender as a result of the operation of the focusing manager.

In an embodiment, the focusing manager converts the focus-moving command input from the user input device into a command to move a highlight corresponding to the selected domain when the selected domain is a DVD-video and then performs the predetermined operation on the focused element.

In an embodiment, when the perform command is input from the user input device with a predetermined menu item highlighted on a menu screen of the DVD-video, the focusing manager converts the perform command into its corresponding command defined in the DVD-video and then performs the predetermined operation on the focused element.

According to yet still another aspect of the present invention, there is provided an apparatus to reproduce DVD-video data in an interactive mode using a mark-up document, including an AV decoder to decode the DVD-video data, a presentation engine to interpret the mark-up document, and a blender to interpret the interpreted mark-up document and the decoded DVD-video data. Here, the presentation engine focuses on an “OBJECT” element and, when a command to move a focus down to a lower focusing layer is input from a user, the presentation engine identifies resource to which the “OBJECT” element refers, converts the focus-moving command that is input from the user into a command to move a highlight defined in the DVD-video data, and moves the highlight when the identified resource is the DVD-video data.

### BRIEF DESCRIPTION OF THE DRAWINGS

These and/or other aspects and/or advantages of the present invention will become more apparent by describing in detail exemplary embodiments thereof with reference to the attached drawings of which:

FIGS. 1A and 1B are diagrams illustrating interactive screens;

FIG. 2 is a diagram illustrating a reproduction system according to an embodiment of the present invention;

FIG. 3 is a block diagram of a reproducer according to an embodiment of the present invention;

FIG. 4 is a block diagram of a presentation engine shown in FIG. 3;

FIG. 5 is a diagram illustrating focusing hierarchy structure according to an embodiment of the present invention;

FIGS. 6 through 8 are diagrams illustrating interactive screens where a focus is differently moved along a focusing hierarchy structure, according to an embodiment of the present invention;

FIG. 9 is a diagram illustrating a process of navigating a DVD-video along a focusing hierarchy structure, according to an embodiment of the present invention when an object element is a DVD-video;

FIGS. 10 through 12 are diagrams illustrating interactive screens where a focus is moved along a focusing hierarchy structure according to an embodiment of the present invention;

FIG. 13 is a flowchart of a focusing method according to an embodiment of the present invention; and

FIG. 14 is a flowchart of a focusing method according to another embodiment of the present invention.

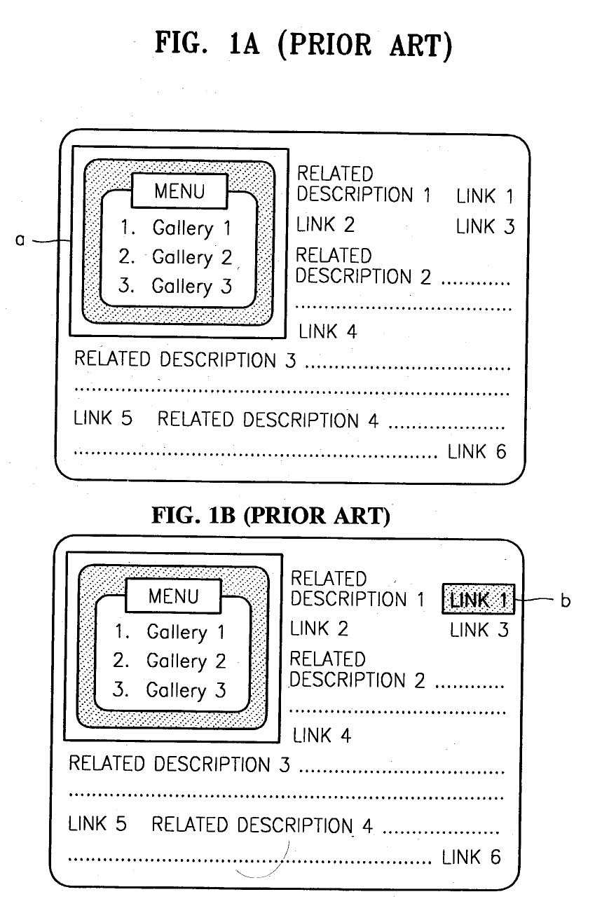

### DETAILED DESCRIPTION OF THE PREFERRED EMBODIMENTS

The present invention will be described more fully with reference to the accompanying drawings in which embodiments of the present invention are shown.

Hereinafter, the term ‘interactive contents’ will refer to contents that can be displayed to a user in an interactive mode. In other words, interactive contents include contents that can be shown to a user by using a mark-up document, files linked to the contents, and AV data as well. Interactive contents can be recorded in a mark-up document. A ‘mark-up document’ is a document written in a mark-up language, such as XML or HTML, and represents mark-up resources including a document like A.xml and A.png, A.jpg, and A.mpeg inserted into A.xml. Accordingly, in this disclosure, a mark-up document serves as an application necessary to reproduce AV data in an interactive mode and provides interactive contents displayed along with the AV data.

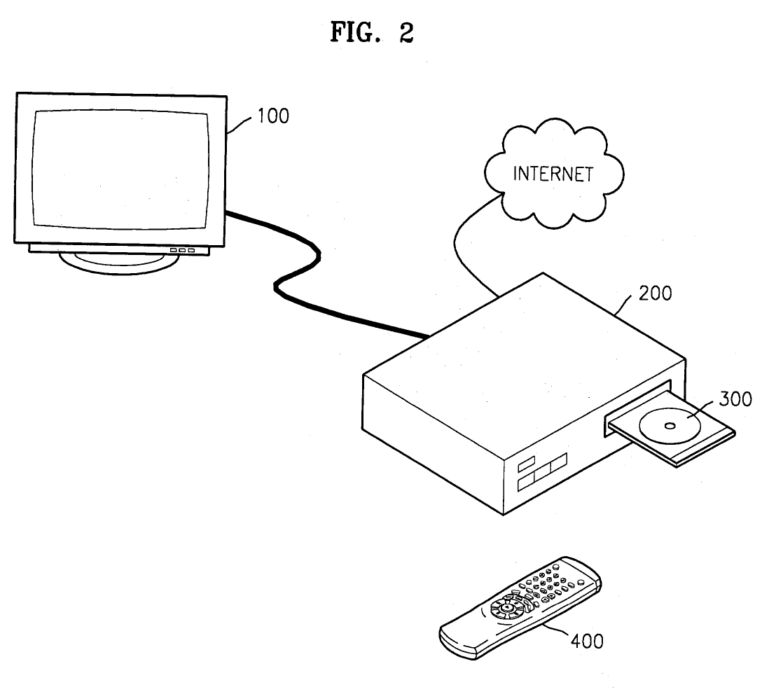

FIG. 2 is a diagram illustrating a reproduction system according to an embodiment of the present invention. Referring to FIG. 2, the reproduction system includes a DVD 300, which is a contents storage medium according to an embodiment of the present invention, a reproducer 200, a TV (television) 100, which is a display device according to an embodiment of the present invention, and a remote controller 400, which is a user input device. The remote controller 400 receives a control command from a user and transmits the control command to the reproducer 200. The reproducer 200 has a DVD drive to read data recorded on the DVD 300. When the DVD 300 is loaded in the DVD drive and a user selects an interactive mode, the reproducer 200 reproduces AV data in an interactive mode by using mark-up documents corresponding to the AV data, and transmits the reproduced AV data to the TV 100 together with the interpreted mark-up documents. A mark-up screen including an AV screen is displayed on the TV 100. The AV screen is obtained based upon the reproduced AV data embedded in the mark-up screen that is obtained based upon a mark-up document. Here, an ‘interactive mode’ represents a way to reproduce AV data so that the AV data can be displayed in a display window in a mark-up document, i.e., a method of displaying AV data so that an AV screen can be embedded in a mark-up screen. A screen displayed in an interactive mode is called an interactive screen. An AV screen and a mark-up screen coexist on an interactive screen. A video mode represents a way to reproduce AV data following a conventional method defined in a DVD-video, i.e., a method of displaying an AV screen obtained by reproducing AV data. In the present embodiment, the reproducer 200 supports both an interactive mode and a video mode. In addition, the reproducer 200 can be connected to a network, such as the Internet so that it can receive and transmit data over the network.

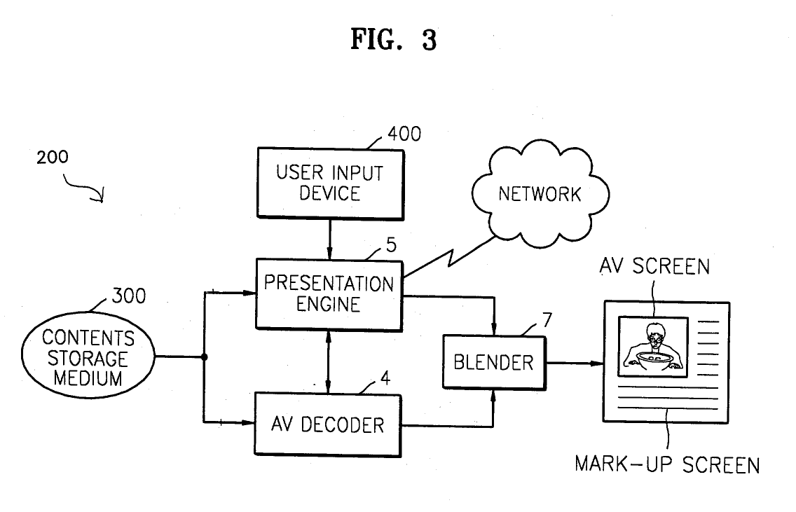

FIG. 3 is a block diagram of an example of the reproducer 200 according to an embodiment of the present invention. Referring to FIG. 3, the reproducer 200 includes a presentation engine 5, an AV decoder 4, and a blender 7. The presentation engine 5 interprets a mark-up document in order to reproduce AV data recorded on a contents storage medium, i.e., the DVD 300, in an interactive mode. In addition, the presentation engine 5 can install or call an application necessary for reproducing interactive contents recorded in a mark-up document. For example, the presentation engine 5 can call WINDOWS MEDIA PLAYER in order to reproduce AV data. The presentation engine 5 can be connected to a network and then bring a mark-up document or interactive contents over the network. The presentation engine 5 focuses on an element or performs the focused element based upon a user command input from the user input device 400. A focus is moved according to a hierarchy structure according to an embodiment of the present invention, which will be described in greater detail later.

In the present embodiment, the user input device 400 includes a key for moving a focus from a lower layer in hierarchy to a higher layer, such as a ‘return’ key, a key for moving a focus from an upper layer to a lower layer, such as an ‘enter’ key, and a key for horizontally moving a focus between elements in the same focusing layer, such as a direction key. These keys are called navigation keys.

When there is a need to move a focus between two different domains, the presentation engine 5 converts a user command for one domain to a command appropriate for the other domain. Supposing that interactive contents displayed to a user in an interactive mode are divided into a mark-up document domain and a DVD-video domain, the presentation engine 5 enables a user to move a focus from a mark-up document domain to a DVD-video domain by converting a command for the mark-up document domain into a command for the DVD-video domain. Here, different domains imply that they have different focusing methods. In other words, it is possible to focus a predetermined element in a mark-up document domain while moving a focus by determining a tabbing order, allotting a number between 0 and 32767 to a ‘tabindex’ attribute of each element, including “A,” “AREA,” “BUTTON,” “INPUT,” “OBJECT,” “SELECT,” or “TEXTAREA,” which has the ‘tabindex’ attribute, and then pressing a tab key (a direction key). Navigation is performed on elements according to a tabbing order determined based on the ‘tabindex’ attribute of each of the elements so that the elements are navigated in an order of an element with a lowest ‘tabindex’ attribute value to an element with a highest ‘tabindex’ attribute value. However, there is no need to sequentially allot a ‘tabindex’ attribute value to each of the elements and start an initial ‘tabindex’ attribute with a predetermined value. Elements having the same ‘tabindex’ attribute value are navigated on a ‘first-come-first-served’ basis. In other words, among elements having the same ‘tabindex’ attribute value in a predetermined sentence, the one that appears first in the predetermined sentence is navigated first, followed by the second and third corners. Thereafter, elements not supporting a ‘tabindex’ attribute or having a ‘tabindex’ attribute value of ‘0’ are navigated on a ‘first-come-first-served’ basis as well. Disabled elements are not included in the tabbing order. Navigation based on a tabbing order, enabled or disabled elements, and a key sequence may vary depending on the structure of the presentation engine 5.

There is another method of focusing on a predetermined element in a mark-up document domain, in which a predetermined key of the user input device is allotted to an ‘accesskey’ attribute of each element, such as “A,” “AREA,” “BUTTON,” “INPUT,” “LABEL,” “LEGEND,” or “TEXTAREA,” and then the predetermined key is used to focus the predetermined element. Accordingly, it is possible to directly focus the predetermined element by using the predetermined key. The process of expressing the ‘accesskey’ attribute of each of the elements may vary depending on the structure of the presentation engine 5. It is preferable for a content creator to make an element include the ‘accesskey’ attribute if a label text or an ‘acce sskey’ attribute is defined for those elements. The presentation engine 5 may underline or color elements for which an access key attribute is set up so as to distinguish these elements from other elements.

If a focused element among elements belonging to a top focusing layer is an object element belonging to a lower focusing layer, such as a Form or a DVD-video, a user presses a perform key, such as an ‘enter’ key, in order to perform a predetermined operation on the focused element. When the user presses a perform key, the presentation engine 5 performs a predetermined operation and converts a focus-moving command into the one appropriate for a lower focusing layer domain.

In a DVD-video domain, a method of transferring highlight information is used to select a menu defined in a DVD-video. Accordingly, when the user tries to move a focus from a mark-up document domain to a DVD-video domain, the presentation engine 5 converts a user command into the one appropriate for the DVD-video domain so that a focus can be moved following a focusing method defined in the DVD-video domain. On the other hand, when a user tries to move a focus from a DVD-video domain to a mark-up document domain, the presentation engine 5 cancels the conversion of the user command so that a focus can be moved following a focusing method defined in the mark-up document domain.

The AV decoder 4 decodes AV data recorded on the contents storage medium 300, i.e., DVD-video data in the present embodiment. The blender 7 blends a decoded DVD-video stream and interpreted mark-up document or decoded interactive contents and then outputs the result of the blending. Accordingly, an interactive screen comprised of a mark-up screen and an AV screen is displayed on a screen of the TV 100.

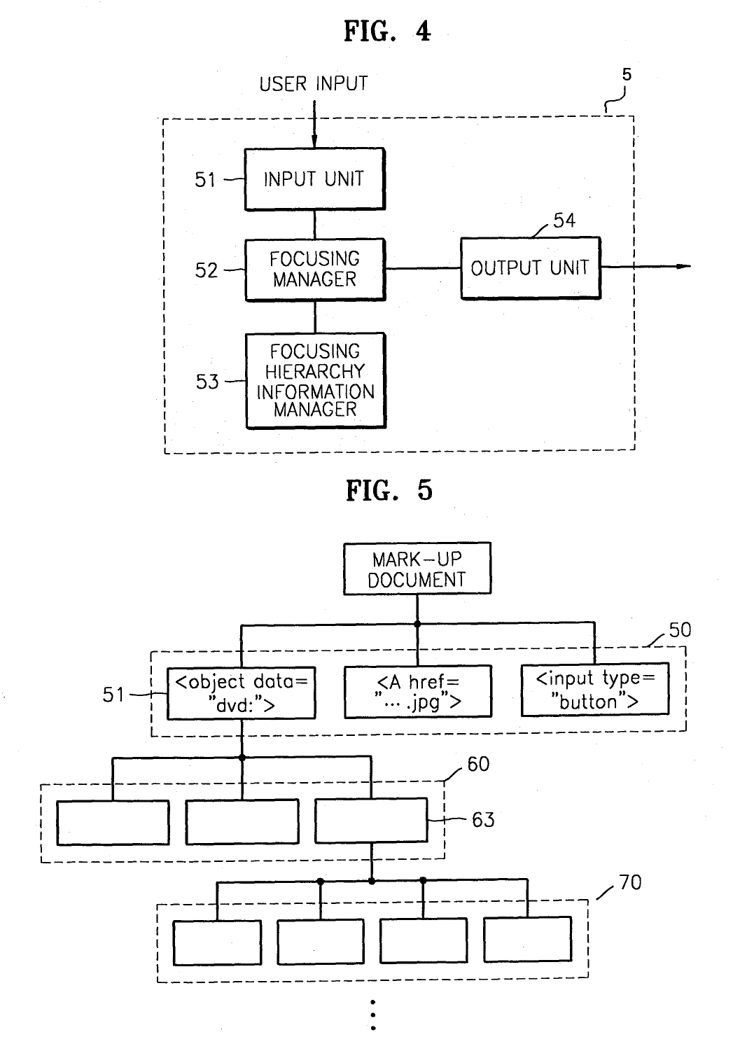

FIG. 4 is a block diagram of the presentation engine 5 of FIG. 3. Referring to FIG. 4, the presentation engine 5 includes an input unit 51, a focusing manager 52, a focusing hierarchy information manager 53, and an output unit 54. The input unit 51 receives a command to move a focus between elements of the same focusing layer or between different focusing layers from the user input device 400. The focusing hierarchy information manager 53 provides focusing hierarchy information to the focusing manager 52. In other words, the focusing hierarchy information manager 53 provides information on a current focusing layer, an upper focusing layer, and a lower focusing layer. The focusing manager 52 shows elements in a current focusing layer which can be focused on, converts a focus-moving command input from the user input device 400 into an API command corresponding to a destination domain, moves a focus to the destination domain referring to the focusing hierarchy information provided by the focusing hierarchy information manager 53. For example, if a selected object is a DVD-video, i.e., if the domain of the selected object is not a mark-up document domain, the focusing manager 52 is provided information on highlight movements defined in the DVD-video, converts the focus-moving command into an API command so as to move a highlight using the information, and provides the API command to the AV decoder 4 so that the highlight can be moved. In addition, when a perform command is input in a focus-on state, i.e., when an ‘enter’ key is pressed by a user, the focusing manager 52 performs a predetermined operation on a predetermined element. In a case where there is a need to show predetermined interactive contents to the user as a result of the predetermined operation, the focusing manager 52 transmits the interactive contents to the blender 7 via the output unit 54. The output unit 54 may include a decoder for decoding interactive contents.

FIG. 5 is a diagram showing a focusing hierarchy structure according to an embodiment of the present invention. According to the focusing hierarchy structure shown in FIG. 5, in the case of reproducing AV data in an interactive mode, i.e., in the case of reproducing AV data using a mark-up document, elements, which can be focused on, exist on a top focusing layer 50 as elements of the mark-up document, and part of a resource to which the elements refer may be navigated. The resource itself may have a data structure that can be navigated, like a DVD-video, or may be navigated with the help of a specific application, like AV data (ASF files or MPEG files) for WINDOWS MEDIA PLAYER. Among elements referring to resource that can be navigated, there are elements belonging to the same domain as a mark-up document, i.e., Form elements, such as “TEXTAREA” or “INPUT,” and an “OBJECT” element which can refer to resources of a different domain, such as a DVD-Video and an AV controller, for example, WINDOWS MEDIA PLAYER or REAL PLAYER.

In FIG. 5, reference numeral 51 represents an “OBJECT” element belonging to the top focusing layer 50. The “OBJECT” element refers to a DVD-video and is linked to a first lower focusing layer 60. When a command to move a focus to a lower focusing layer is input after the “OBJECT” element 51 is focused on, the focus is moved to the first lower focusing layer 60 that is linked to the “OBJECT” element 51. Reference numeral 63 represents an element belonging to the first lower focusing layer 60. The element 63 is linked to a second lower focusing layer 70.

In the case of reproducing a DVD-video in an interactive mode, a user may move a focus of a DVD-video object element using a direction key provided at the user input device 400, such as a remote controller, and then move the focus again to a lower focusing layer linked to the DVD-video object element by hitting an ‘enter’ key. If the focus is moved to the lower focusing layer, navigation can be performed based on what is defined in the lower focusing layer, using the direction key. According to the focusing hierarchy structure of the present invention, it is possible to navigate the inside of an object element of a different domain from a mark-up document.

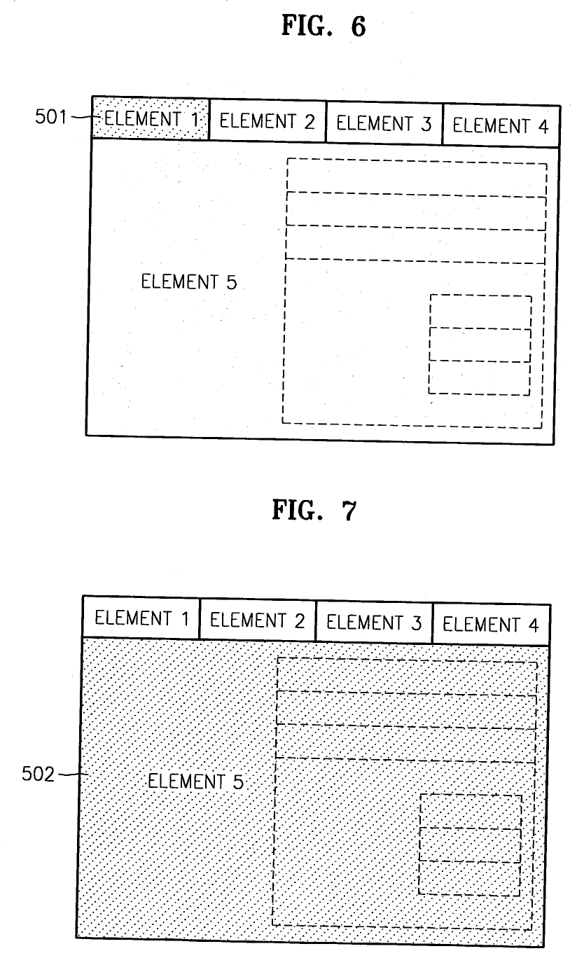

FIGS. 6 through 8 are diagrams illustrating a process of navigating interactive contents by moving a focus along a focusing hierarchy structure according to an embodiment of the present invention. Referring to FIGS. 6 through 8, a mark-up document includes elements 1 through 5, which belong to a top focusing layer. At least one lower focusing layer is linked to element 5. A user can focus elements 1 through 5 belonging to the top focusing layer using keys provided at the user input device 400 and can focus and navigate elements belonging to the lower focusing layer linked to element 5.

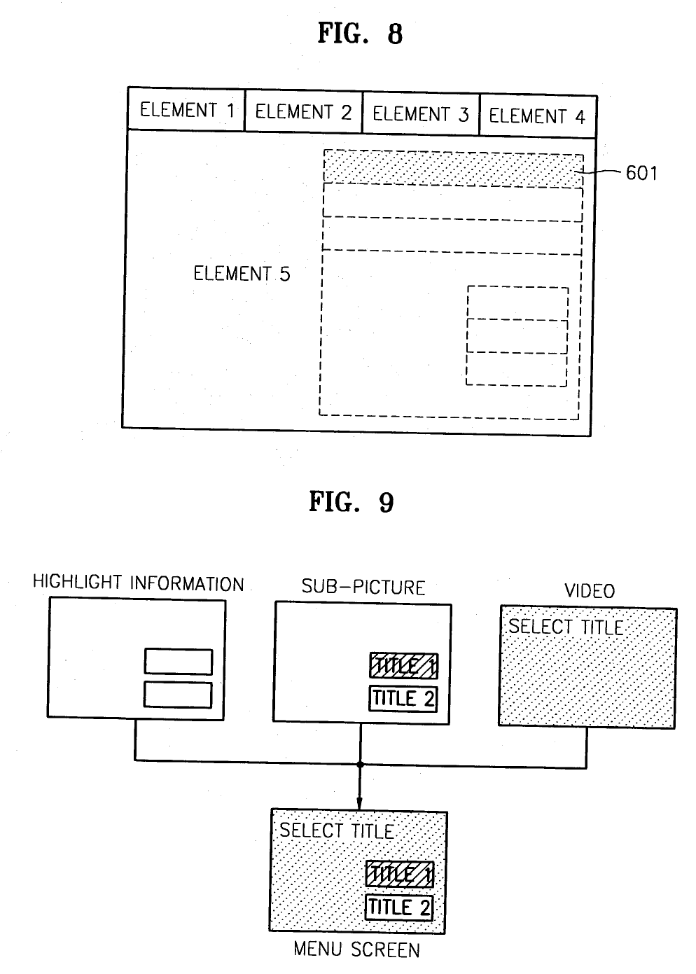

FIG. 6 shows that element 1 is focused on. FIG. 7 shows that element 5 is focused on. FIG. 8 shows that a lower focusing element 601 that is linked to element 5 is focused on by a user hitting a focusing-layer moving key (‘enter’ key) of the user input device 400 after focusing on element 5.

Since a focus can be moved between different focusing layers, it is preferable to provide information on a focusing layer currently being navigated to the user by using different colors or different shapes to display different focusing layers in a focus-on state.

FIG. 9 is a diagram illustrating a process of navigating a DVD-video along a focusing hierarchy structure according to an embodiment of the present invention, in a case where resource to which an “OBJECT” element refers is a DVD-video. Referring to FIG. 9, a menu screen of a DVD-video is comprised of highlighted information, a sub-picture, and a video. In the highlighted information, a color palette used for highlighting a menu item (title 1 or title 2) selected by a user, and commands to be performed, are described. A highlighted menu item is expressed by a color different from that of a menu item not highlighted by the sub-picture.

In order to navigate data recorded on a DVD-video along a focusing hierarchy structure according to the present invention, a command to move a focus to the DVD-video input by a user must be converted so that its corresponding command described in the highlighted information can be performed. In addition, when a command to move a focus from the DVD-video to a mark-up document domain is input, the conversion of the command to move a focus to the DVD-video is cancelled. In the present invention, the conversion and cancellation of a command is performed by an application program interface (API).

A user focuses on an object belonging to a top focusing layer of a mark-up document and then hits a perform key, such as an ‘enter’ key, in order to perform a predetermined operation defined in the focused object. When the user hits the perform key, the predetermined operation is performed, and at the same time, a focus is moved to a lower focusing layer linked to the focused object. In most cases, it is possible to figure out the domain of lower focusing layers in a mark-up document. However, a property may be used to identify the domain of a lower focusing layer and then move a focus to the lower focusing layer (i.e., to convert a navigation command into the one appropriate for a focusing method defined in the focused object). An example of the property used for identifying the domain of a lower focusing layer is as follows.

Interactive DVD.DomainState

1) Summary

A state value of a domain currently being focused on is returned.

2) Return value

ECMAScript Number Signed 1 byte integer ranging from 0-7 where:

0: HTML Domain

1: XHTML Domain

2: SMIL Domain

3: DVD-Video Domain

4: DVD-Audio Domain

5: Another Video Data Domain

6: Another Audio Data Domain

7: Reserved

3) Example

A current domain is identified.

domain=InteractiveDVD.DomainState

As described above, the focusing manager 52 uses a property indicating the domain of a lower focusing layer in a mark-up document. If a return value of the property is the same as a state value 0, 1, or 2 of a mark-up document, focusing for navigation is performed by tabindex and accesskey, according to what is defined in the mark-up document 0, 1, or 2. However, if a return of the property is 3, which indicates a DVD-video, the focusing manager 52 converts a focus-moving command input from a user into a command to move highlight information in a DVD-video. If a command to move a focus toward an upper focusing layer is input from the user, i.e., if the user hits a ‘return’ key, the focusing manager 52 cancels the conversion of the focus-moving command into the highlight-moving command for a DVD-video.

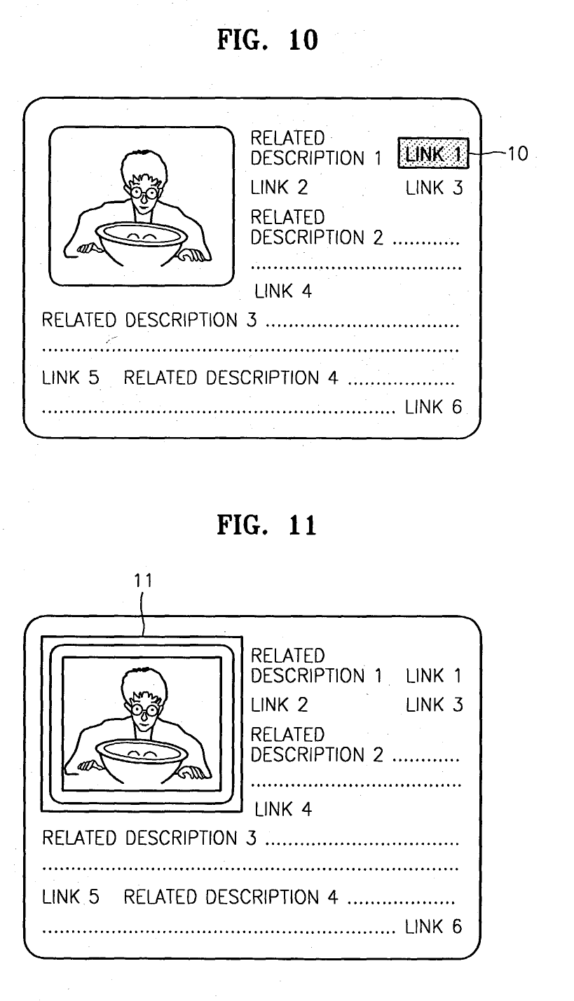

FIGS. 10 through 13 are diagrams illustrating interactive screens on which a focus is moved along a focusing hierarchy structure according to an embodiment of the present invention. On an interactive screen shown in FIG. 10, link 1, which is one of elements belonging to a top focusing level, is focused on, as marked by 10. A user can move a focus between the elements belonging to the top focusing layer by hitting a direction key of the user input device 400.

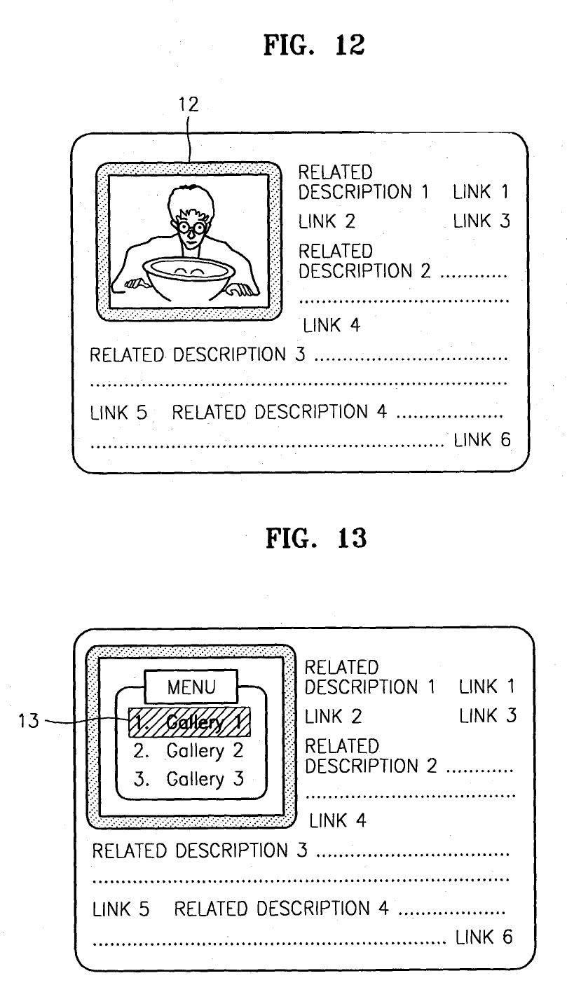

On an interactive screen shown in FIG. 11, an “OBJECT” element 11, which belongs to a top focusing layer and refers to a resource of a different domain from a mark-up document, i.e., a DVD-video, is focused on. On an interactive screen as shown in FIG. 12, the presentation engine 5 changes the color of an edge 12 of an AV screen where a DVD-video is displayed in order to show that a focus is moved to a lower focusing layer.

FIG. 13 shows a menu screen displayed on an AV screen. On the menu screen, menu items that can be selected are displayed, and one item 13 of the menu items, which is set as a default value, is highlighted. The menu items are sequentially highlighted by hitting a focus-moving key (direction key) provided at the user input device 400.

A focusing method according to an embodiment of the present invention will be described in the following paragraphs based on the structure of the focusing apparatus which has been described above.

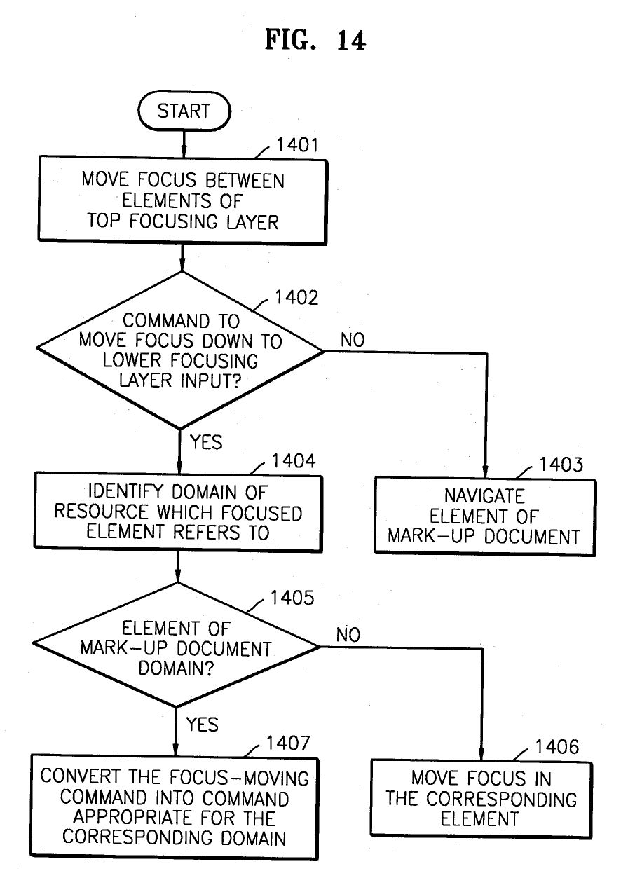

FIG. 14 is a flowchart of a focusing method according to another embodiment of the present invention. Referring to FIG. 14, when the DVD 300 is loaded in the reproducer 200, a selection screen for allowing a user to select either an interactive mode or a video mode is displayed on the screen of the TV 100 by a mark-up document designated as a start document. When the user selects an interactive mode, an interactive screen including an AV screen set as a default value and its corresponding mark-up screen is displayed. A focus is moved to one of the elements belonging to a top focusing layer in operation 1401 by the user hitting a direction key. If a command to move the focus to a lower focusing layer is not input in operation 1402, focusing can only be performed between the elements of the top focusing layer. In other words, the user can navigate mark-up document elements using a direction key in operation 1403.

If a command to move the focus to a lower focusing layer is input in operation 1402, the domain of resource which a focused element refers to is identified in operation 1404. As a result of the identification, if the resource is not a resource of a mark-up document domain but a resource of a different domain, for example, a DVD-video, in operation 1405, the presentation engine 5 converts the focus-moving command input from the user into a command appropriate for the corresponding domain in operation 1406 so that elements of the corresponding domain can be navigated. Accordingly, navigation can be performed according to what is defined in the focused element in operation 1406. If a direction key is hit with the focus moved to a lower focusing layer, a focus is moved between elements of the lower focusing layer rather than being moved up to an upper focusing layer, i.e., focusing is only performed within the DVD-video. A focus can be moved up to an upper focusing layer by pressing a return key. A focus can be moved down to a second lower focusing layer by focusing on an element linked to the second lower focusing layer first and then pressing an enter key.

If a command to move the focus down to a lower focusing layer is input in operation 1402, the domain of a focused object element is identified in operation 1404. If the focused object element is an element of a mark-up document domain, i.e., a Form-style element, in operation 1405, the presentation engine 5 moves the focus according to what is defined in the mark-up document domain, i.e., the presentation engine 5 does not convert the command, in operation 1407. At this time, if a user presses a direction key, the focus is only moved within a lower focusing layer moving from element to element rather than being moved up to an upper focusing layer, i.e., a focus is only moved within a Form object element. As described above, a focus can be moved up to an upper focusing layer by pressing a return key. In addition, focus can be moved down to a second lower focusing layer by focusing on an element linked to the second lower focusing layer first and then pressing an enter key.

As described above, according to the present invention, it is possible to navigate an object, which is embedded in a mark-up screen in an interactive mode and belongs to a domain other than a mark-up document domain, using a focus-moving method. In other words, it is possible to navigate the mark-up screen and elements inside the object embedded in the markup screen by moving a focus using a limited user input device.

The hardware included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although a few embodiments of the present invention have been shown and described, it would be appreciated by those skilled in the art that changes may be made in these embodiments without departing from the principles and spirit of the present invention, the scope of which is defined in the claims and their equivalents.

What is claimed is:

1. A data storage medium comprising:
AV data; and
a mark-up document used for reproducing the AV data in an interactive mode,
wherein the mark-up document is made using a focusing hierarchy structure so that a resource to which an element of the mark-up document refers and a domain that is different from that of the mark-up document can be navigated.

2. The data storage medium of claim 1, wherein the AV data are DVD-video data, and the mark-up document is made using the focusing hierarchy structure so that the DVD-video data is navigable.

3. A focusing method in an interactive mode where AV data are reproduced using a mark-up document, comprising:
identifying a domain of a resource to which a focused element refers when a command to move a focus between focusing layers is input from a user; and
moving the focus by converting the focus-moving command into a command appropriate for the identified domain, when the identified domain is not a mark-up document domain.

4. The focusing method of claim 3, further comprising:
canceling the conversion of the focus-moving command when a command to move the focus up to the top focusing layer is input from the user.

5. The focusing method of claim 3, further comprising:
identifying a domain of a second lower focusing layer when a command to move a focus to the second lower focusing layer is input from the user; and
moving the focus by converting the focus-moving command input from the user into a command appropriate for the identified domain.

6. A focusing method in an interactive mode where AV data are reproduced using a mark-up document, comprising:
focusing on one of a plurality of mark-up document elements belonging to a top focusing layer;
identifying a domain of resource to which the focused mark-up document element refers when a command to move a focus down to a first lower focusing layer is input from a user; and
moving the focus by converting the focus-moving command into a command appropriate for the identified domain, when the identified domain is not a mark-up document domain.

7. The focusing method of claim 6, further comprising:
canceling the conversion of the focus-moving command when a command to move the focus up to the top focusing layer is input from the user.

8. The focusing method of claim 6, further comprising:
identifying a domain of a second lower focusing layer when a command to move a focus to the second lower focusing layer is input from the user; and
moving the focus by converting the focus-moving command input from the user into a command appropriate for the identified domain.

9. A focusing method in an interactive mode where DVD-video data are reproduced using a mark-up document, comprising:
focusing on an “OBJECT” element;
identifying a resource to which the “OBJECT” element refers when a command to move a focus to a lower focusing layer is input from a user; and
moving a highlight by converting the focus-moving command that is input from the user into a command to move a corresponding highlight defined in the DVD-video data.

10. The focusing method of claim 9, wherein the moving the highlight comprises moving a highlight in a menu screen based upon the focus-moving command that is input from the user.

11. An apparatus to reproduce AV data in an interactive mode using a mark-up document, comprising:
an AV decoder to decode the AV data;
a presentation engine to interpret the mark-up document; and
a blender to blend the interpreted mark-up document and the decoded AV data,
wherein when a command to move a focus between focusing layers is input from a user, the presentation engine identifies a domain of a resource to which a focused element refers and converts the focus-moving command that is input from the user into a command appropriate for the identified domain only when the identified domain is not a mark-up document domain.

12. An apparatus to reproduce AV data in an interactive mode using a mark-up document, comprising:
an AV decoder to decode the AV data;
a presentation engine to interpret the mark-up document; and
a blender to blend the interpreted mark-up document and the decoded AV data,
wherein the presentation engine comprises:
an input unit to receive a command to move a focus between elements of a same focusing layer or between different focusing layers from a user input device;
a focusing hierarchy information manager to provide focusing hierarchy information;
a focusing manager to show elements that can be focused on in a current focusing layer, to convert the focus-moving command input from the user input device into an API command corresponding to a selected domain, to receive the focusing hierarchy information from the focusing hierarchy information manager so as to move a focus, and to perform a predetermined operation on a focused element when a perform command is input from the user input device; and
an output unit to output interactive contents to the blender as a result of the operation of the focusing manager.

13. The apparatus of claim 12, wherein the focusing manager converts the focus-moving command input from the user input device into a command to move a highlight corresponding to the selected domain when the selected domain is a DVD-video and then performs the predetermined operation on the focused element.

14. The apparatus of claim 13, wherein when the perform command is input from the user input device with a predetermined menu item highlighted on a menu screen of the DVD-video, the focusing manager converts the perform command into its corresponding command defined in the DVD-video and then performs the predetermined operation on the focused element.

15. An apparatus for to reproduce DVD-video data in an interactive mode using a mark-up document, comprising:
an AV decoder to decode the DVD-video data;
a presentation engine to interpret the mark-up document; and
a blender to blend the interpreted mark-up document and the decoded DVD-video data,
wherein the presentation engine focuses on an “OBJECT” element, and when a command to move a focus down to a lower focusing layer is input from a user, the presentation engine identifies resource to which the “OBJECT” element refers, converts the focus-moving command that is input from the user into a command to move a highlight defined in the DVD-video data, and moves the highlight when the identified resource is the DVD-video data.

16. The data storage medium of claim 1, wherein the resource is a DVD-video.

17. The data storage medium of claim 16, wherein a menu screen of the DVD-video comprises:
highlighted information, wherein in the highlighted information, a color palette is used for highlighting a menu item that is selected by a user and commands to be performed;
a sub-picture; and
a video.

18. The data storage medium of claim 17, wherein a highlighted menu item is expressed by a different color from that of a menu item that is not highlighted by the sub-picture.

19. The focusing method of claim 4, wherein the conversion and cancellation of a command is performed-by an application program interface (API).

20. The apparatus of claim 12,
wherein each element includes a tabindex attribute,
wherein elements having the same tabindex attribute are navigated on a first-come-first-served basis, and
wherein navigation of elements is based on the structure of the presentation engine.

21. A focus-moving method, for navigating an object, which is embedded in a markup screen in an interactive mode, and which belongs to a domain other than a mark-up document domain, comprising:
navigating the mark-up screen and elements included in the object embedded in the mark-up screen by moving a focus using a limited user input device.
